(19) United States
(12) Patent Application Publication
(10) Pub. No.: US 2025/0271682 A1
(43) Pub. Date: Aug. 28, 2025

(54) LIGHT SOURCE MODULE AND PROJECTION DEVICE

(71) Applicant: Coretronic Corporation, Hsin-Chu (TW)

(72) Inventors: Yan Wen Lin, Hsin-Chu (TW); Hung-Pin Chen, Hsin-Chu (TW); Chun-Hsin Lu, Hsin-Chu (TW); Wen-Chieh Chung, Hsin-Chu (TW); Wen-Chun Wang, Hsin-Chu (TW)

(73) Assignee: Coretronic Corporation, Hsin-Chu (TW)

(21) Appl. No.: 19/048,803

(22) Filed: Feb. 7, 2025

(30) Foreign Application Priority Data
Feb. 22, 2024 (CN) 202410195284.8

(51) Int. Cl. G02B 27/28; G02B 27/09; G02B 27/18

(52) U.S. Cl. CPC G02B 27/283; G02B 27/0961; G02B 27/0972; G02B 27/18

(57) ABSTRACT

A light source module includes a light source emitting an illumination beam having a first polarization state, a polarizing beam splitter disposed on a light exit side of the light source, a QWF disposed between the polarizing beam splitter and the lens array, a first reflector, and a lens array disposed between the first reflector and the QWF. The illumination beam is transmitted to the polarizing beam splitter, the QWF, the lens array, and the first reflector sequentially; after being reflected by the first reflector to return in a reverse direction, the illumination beam is converted into a second polarization state different from the first polarization state, and is transmitted to and then moved away from the polarizing beam splitter. A projection device having the light source module is also provided.

### CROSS-REFERENCE TO RELATED APPLICATION

This application claims the priority benefit of China application serial no. 202410195284.8, filed on Feb. 22, 2024. The entirety of the above-mentioned patent application is hereby incorporated by reference herein and made a part of this specification.

### BACKGROUND

### Technical Field

The invention relates to an imaging system and in particular relates to a light source module and a projection device.

### Description of Related Art

Projection devices are used to generate large-area images. With the continuous advancements and innovative strides in technologies, the projection devices are increasingly widely used in the consumer market. The imaging principle of the projection device is to illuminate a light valve with an illumination beam generated by a light source module, convert the illumination beam into an image beam via the light valve, and then project the image beam onto a target object (such as a screen or wall) through a projection lens, thereby presenting a display image.

Presently, the reduction of volume and the alleviation of weight in the projection devices have become the focus of research and development of the projection devices. However, as the size reduction continues, it is crucial to maintain the essential requirement of achieving uniform illumination originating from the light source module. This necessitates tackling issues (such as minimizing light speckles and achieving a consistent average light intensity) which are substantial concerns for manufacturers operating in the pertinent field.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

In order to achieve one or a portion of or all of the objects or other objects, an embodiment of the invention provides a light source module that includes a light source, a polarizing beam splitter, a lens array, a quarter wave film (QWF), and a first reflector. An illumination beam emitted by the light source has a first polarization state. The polarizing beam splitter is disposed on a light exit side of the light source. The lens array is disposed on one side of the polarizing beam splitter. The QWF is disposed between the polarizing beam splitter and the lens array. The lens array is disposed between the QWF and the first reflector. Here, the illumination beam from the light source is first transmitted to the polarizing beam splitter and then sequentially transmitted to the QWF, the lens array, and the first reflector along a first path, and after the illumination beam is reflected by the first reflector, the illumination beam is converted into a second polarization state different from the first polarization state, returns along the first path to transmit to the polarizing beam splitter, and is moved away from the polarizing beam splitter after passing through the polarizing beam splitter.

In order to achieve one or a portion of or all of the objects or other objects, an embodiment of the invention provides a projection device that includes the aforesaid light source module, a light valve, and a projection lens. The light valve is disposed on a light path of the illumination beam and configured to convert the illumination beam into an image beam. The projection lens is disposed on the light exit side of the light valve and configured to transmit the image beam out of the projection device to generate a projection image.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a light path of a light source module and a projection device according to an embodiment of the invention.

FIG. 2 is a schematic view of a light path of a light source module and a projection device according to another embodiment of the invention.

FIG. 3A and FIG. 3B are schematic views illustrating comparison of image beam intensity in the projection device according to respective embodiments of the invention.

FIG. 4 is a schematic view of a light path of a light source module and a projection device according to yet another embodiment of the invention.

FIG. 5 is a schematic view of a light path of a light source module and a projection device according to still another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

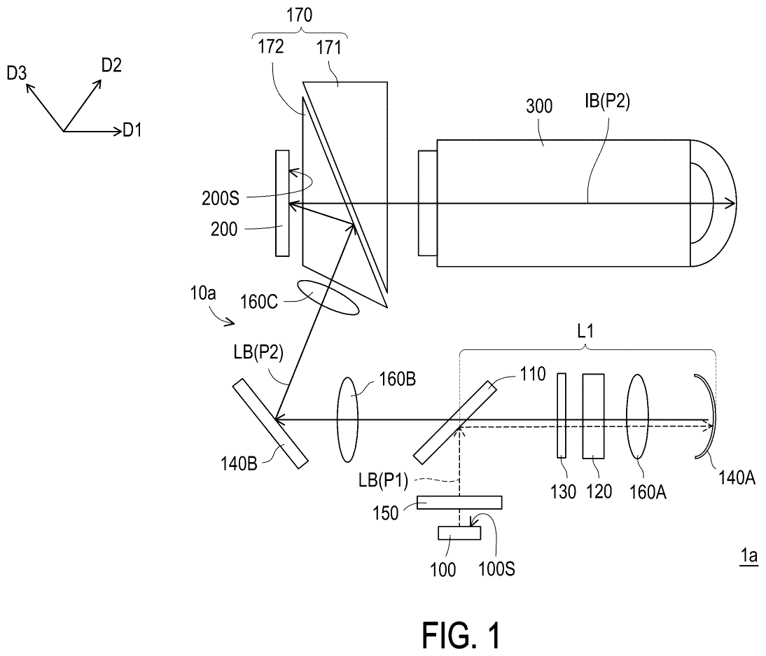

FIG. 1 is a schematic view of a light path of a light source module and a projection device according to an embodiment of the invention. With reference to FIG. 1, a projection device 1a provided in this embodiment includes a light source module 10a, a light valve 200, and a projection lens 300. The light valve 200 is disposed on a transmission path of an illumination beam LB from the light source module 10a to convert the illumination beam LB into an image beam IB. In this embodiment, the light valve 200 is, for instance, a digital micro mirror device (DMD), a liquid crystal on silicon panel (LCOS panel), or any other suitable spatial light modulator (SLM). However, in other embodiments (not shown), the light valve 200 may also be a transmissive liquid crystal panel, which should however not be construed as a limitation to the invention. The projection lens 300 is disposed on a light exit side of the light valve 200 and is disposed on a transmission path of the image beam IB to project the image beam IB out of the projection device 1a; for instance, the image beam IB is projected onto a screen to form a projection image.

The projection lens 300 is, for instance, composed of one or more optical lenses with refracting power, such as various combinations of biconvex lenses, concave-convex lenses, plano-convex lenses, biconcave lenses, plano-concave lenses, convex-concave lenses, or non-planar lenses. The type or the kind of the projection lens 300 is not construed as a limitation to the invention.

The light source module 10a includes a light source 100, a polarizing beam splitter 110, a lens array 120, a quarter wave film (QWF) 130, and a first reflector 140A. The light source 110 is configured to emit an illumination beam LB, and the illumination beam LB has a first polarization state P1. The polarizing beam splitter 110 is disposed on a light exit side 100S of the light source 100. The lens array 120 is disposed on one side of the polarizing beam splitter 110; for instance, both the light source 100 and the lens array 120 may be located on the same side of the polarizing beam splitter 110. The QWF 130 is disposed between the polarizing beam splitter 110 and the lens array 120, and the lens array 120 is located between the first reflector 140A and the QWF 130.

Specifically, the light source 100 may be, for instance, a laser diode or a solid-state laser, and in some embodiments, the light source 100 may also be other types of light sources, such as light-emitting diodes, etc., which should not be construed as a limitation to the invention. Moreover, the illumination beam LB emitted by the light source 100 has the first polarization state P1, which may be, for instance, S-polarized light, i.e., the linear polarization direction of the illumination beam LB is perpendicular to a plane of incidence constituted by an incident radiation and a reflection radiation of the illumination beam LB. After receiving the illumination beam LB, the polarizing beam splitter 110 may reflect the illumination beam LB having the first polarization state P1, so as to enable the illumination beam LB to be transmitted to the QWF 130 and enter a first path L1. The angle of incidence of the illumination beam LB on a reflection surface of the polarizing beam splitter 110 may be, for instance, 45 degrees, and the type of the polarizing beam splitter 110 may be a plate beam splitter or a cube beam splitter, which should not be construed a limitation to the invention.

From the polarizing beam splitter 110 to the first reflector 140A on the first path L1, at least the QWF 130 and the lens array 120 are provided in sequence. When the illumination beam LB irradiates the QWF 130, the first polarization state P1 of the illumination beam LB may be changed by the QWF 130. For instance, the illumination beam LB may be vertically incident to a light incidence side of the QWF 130, and there may be a specific angle (e.g., 45 degrees) between the linear polarization direction of the first polarization state P1 and a fast axis direction of the QWF 130; through the phase delay of the QWF 130, the first polarization state P1 is converted into a circular polarization state (e.g., left-handed circularly polarized light), which should not be construed as a limitation to the invention. As such, the illumination beam LB may be transmitted to the lens array 120 located on the light path of the illumination beam LB.

The lens array 120 may include a plurality of micro lenses disposed on a light incidence side of the lens array 120 (i.e., the side facing the QWF 130 or the side facing the first reflector 140A); alternatively, the micro lenses may also be disposed on both light incidence sides of the lens array 120 (i.e., the side facing the QWF 130 and the side facing the first reflector 140A), which should not be construed as a limitation to the invention. Through the first incidence to the lens array 120, the intensity of the illumination beam LB may be homogenized.

After passing through the lens array 120, the illumination beam LB may then be irradiated to a first convergence lens 160A. The first convergence lens 160A is disposed between the lens array 120 and the first reflector 140A, and a light beam passing through the lens array 120 may be converged to the first reflector 140A by the first convergence lens 160A; alternatively, during a light homogenization process of the lens array 120, the light beam transmitted out of the lens array 120 and deviating from the first path L1 may be re-converged to the first reflector 140A, so as to further increase the light energy utilization rate. Certainly, this should not be construed as a limitation to the invention.

After being reflected by the first reflector 140A, the illumination beam LB, which is the circularly polarized light (e.g., the left-handed circularly polarized light), may be converted into another circularly polarized light (e.g., right-handed circularly polarized light) and re-transmitted back to the first path L1. The first reflector 140A may be a freeform reflector, a spheric reflector, an aspheric reflector, or a plane mirror, which should not be construed as a limitation to the invention. On the other hand, optimal light convergence and reflection effects of the illumination beam LB may be achieved by designing or adjusting the curvature or the deviation angle of a reflection surface of the first reflector 140A, so that the reflected illumination beam LB may return in a reverse direction along the first path L1 and re-enter the lens array 120. A focal point of the first reflector 140A, for instance, may be located between the first convergence lens 160A and the first reflector 140A or at a center position of the lens array 120, so that the light field distribution of the illumination beam LB reflected by the first reflector 140A may match the shape of the light incidence surface of the lens array 120 after the illumination beam LB is converged by the first convergence lens 160A, thereby increasing the energy utilization rate of the illumination beam LB.

As mentioned above, the illumination beam LB returns in the reverse direction along the first path L1 and is transmitted to the lens array 120 again, and the illumination beam LB leaves the lens array 120 after being re-homogenized by the lens array 120. Repeated homogenization of the illumination beam LB as the illumination beam LB passes back and forth through the same lens array 120 significantly improves the uniformity of the light intensity of the illumination beam LB. Additionally, this process reduces the number of light homogenization elements, simplifies the design of the light path, and saves space for optical element placement. Consequently, the volume, the weight, the manufacturing difficulty, and the manufacturing cost of the light source module 10a and the projection device 1a are reduced. Specifically, compared with the light path structure of a conventional projection device that uses a plurality of lens arrays to achieve the light homogenization effects, the volume of the projection device 1a provided in the embodiment of the invention may be reduced by approximately 80.9%, which is beneficial to the lightweight of the projector.

After the illumination beam LB leaves the lens array 120 again, the illumination beam LB is also transmitted to the QWF 130 again, and the circular polarization state of the illumination beam LB (e.g., the right-handed circularly polarized light described above) may be converted into a second polarization state P2 by the QWF 130, wherein the second polarization state P2 is different from the first polarization state P1. For instance, the second polarization state P2 is, for instance, a P polarization state; namely, a linear polarization direction of the illumination beam LB, is parallel to a plane of incidence constituted by the incident radiation and the reflection radiation of the illumination beam LB, which should certainly not be construed as a limitation to the invention. After the illumination beam LB, of which the polarization state has been converted into the second polarization state P2, is transmitted to the polarizing beam splitter 110 again, the illumination beam LB may be moved away from the polarizing beam splitter 110 after passing through the polarizing beam splitter 110. At this stage, the light source module 10a is able to generate the homogenized illumination beam LB.

In some embodiments, the light source module 10a may further include a speckle elimination element. For instance, the light source module 10a may include a diffusion sheet 150 disposed on the light exit side 100S of the light source 100, e.g., the diffusion sheet 150 is disposed between the light source 100 and the polarizing beam splitter 110. When the light source 100 is, for instance, a laser light source, the speckle of the illumination beam LB may be eliminated by the diffusion sheet 150. In some embodiments, the diffusion sheet 150 may be an actuating diffusion sheet, a light incidence surface of the diffusion sheet 150 and the light exit side 100S of the light source 100 may be substantially parallel to each other, for instance, the diffusion sheet 150 may reciprocate on an imaginary plane parallel to the light exit side 100S, thereby enhancing the speckle elimination effect of the diffusion sheet 150. The diffusion sheet 150 may also be a diffusion wheel, which enhances the speckle elimination effect of the diffusion sheet 150 by rotating the wheel surface. This should not be construed as a limitation to the invention.

On the other hand, the light source module 10a may further include a second convergence lens 160B disposed on one side of the lens array 120 away from the first reflector 140A. For instance, a virtual extension plane of the reflection surface of the polarizing beam splitter 110 configured to reflect the illumination beam LB in FIG. 1 as an example, wherein the second convergence lens 160B and the light source 100 are respectively located on two opposite sides of the virtual extension plane. Specifically, in the light source module 10a of the projection device 1a, the light source 100, the QWF 130, the lens array 120, and the first reflector 140A are located on one side of the virtual extension plane of the polarizing beam splitter 110, while the second convergence lens 160B is located on the other side of the virtual extension plane. The second convergence lens 160B may converge and calibrate the illumination beam LB, thereby improving the light energy utilization rate of the illumination beam LB. This should not be construed as a limitation to the invention.

In some embodiments, the polarizing beam splitter 110, the lens array 120, the first convergence lens 160A, the second convergence lens 160B, and the QWF 130 may all be disposed in the first direction D1. In some embodiments, optical axes of the polarizing beam splitter 110, the lens array 120, the first convergence lens 160A, the second convergence lens 160B, and the QWF 130 and the first path L1 may be overlapped to simplify the design of the light path. In some embodiments, a direction in which the polarizing beam splitter 110, the lens array 120, the first convergence lens 160A, the second convergence lens 160B, and the QWF 130 are arranged may be substantially parallel to a light exit direction of the projection lens 300 for effectively utilizing the space of the projection device 1a and further reducing the volume of the projection device 1a.

In some embodiments, the light source module 10a may further include a second reflector 140B. The second convergence lens 160B is located between the polarizing beam splitter 110 and the second reflector 140B. The second reflector 140B may be used to adjust a travel direction of the illumination beam LB, so as to direct the illumination beam toward other optical components or the light valve 200. For instance, the second reflector 140B may be suitable for reflecting the illumination beam LB coming from the second convergence lens 160B, thus directing the illumination beam LB to travel toward the second direction D2. Here, the first direction D1 is different from the second direction D2.

In some embodiments, the light source module 10a may further include a third convergence lens 160C and a prism group 170. The third convergence lens 160C may be positioned between the second reflector 140B and the prism group 170 and configured to converge or collimate the illumination beam LB and focus and transmit the illumination beam LB to the prism group 170. The prism group 170 may be positioned between the light valve 200 and the projection lens 300. The prism group 170 may include a first prism 171 and a second prism 172 and is suitable for receiving the illumination beam LB from the second reflector 140B and the third convergence lens 160C, enabling the illumination beam LB to undergo total internal reflection between the interface of the first prism 171 and the second prism 172, and then being transmitted in a third direction D3 and illuminating the light exit side 200S of the light valve 200, so as to complete the above-mentioned process of converting the illumination beam LB into the image beam IB. The third direction D3 may be different from the first direction D1 and the second direction D2, which should not be construed as a limitation to the invention. It should be specifically noted that the above-mentioned illumination beam LB may be a non-parallel light beam, and thus the description “the illumination beam LB travels along the first direction D1, the second direction D2, or the third direction D3” may refer to a transmission direction of the light beam with the maximum light intensity in the illumination beam LB.

Some other embodiments will be provided below to elaborate the invention, where the same components will be marked by the same reference numbers, and the description of the same technical content will be omitted. The descriptions of the omitted parts may be referred to as those provided in the previous embodiments and will not be further elaborated below.

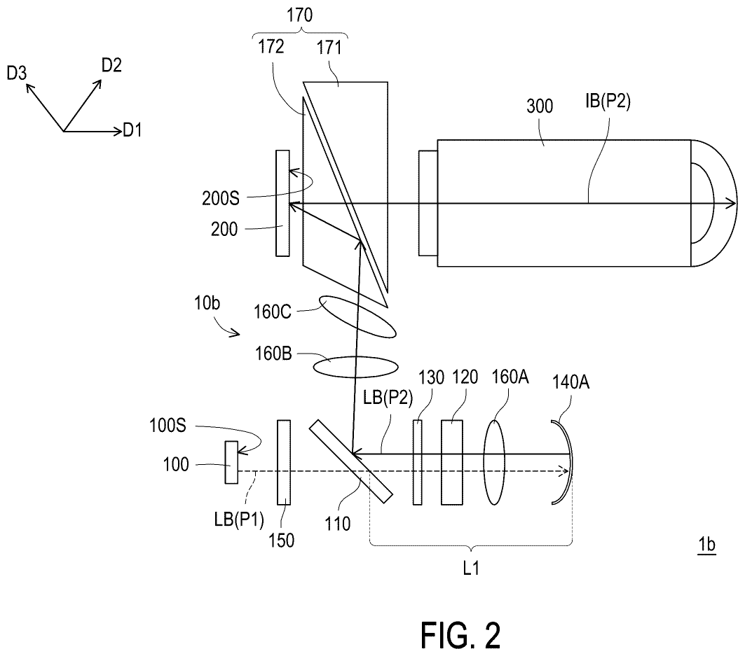

FIG. 2 is a schematic view of a light path of a light source module and a projection device according to another embodiment of the invention. With reference to FIG. 2, a projection device 1b and a light source module 10b are similar to the projection device 1a and the light source module 10a depicted in FIG. 1, while the main difference therebetween lies in the placement location of the light source 100. Specifically, in the light source module 10b of the projection device 1b, the light source 100 is disposed on one side of the virtual extension plane of the polarizing beam splitter 110, while the QWF 130, the lens array 120, the first reflector 140A, the first convergence lens 160A, and the second convergence lens 160B are all located on the other opposite side of the virtual extension plane.

Specifically, in the light source module 10b, the first polarization state P1 of the illumination beam LB emitted by the light source 100 is, for instance, a P polarization state. After the illumination beam LB passes through the diffusion sheet 150, the illumination beam LB may pass through the polarizing beam splitter 110. Then, along the first path L1, the illumination beam LB sequentially passes through the QWF 130 and is converted into the circularly polarized light, homogenized by the lens array 120, converged by the first convergence lens 160A, and reflected by the first reflector 140A to be converted into another circularly polarized light, and the illumination beam LB then returns to pass through the first convergence lens 160A, the lens array 120, and the QWF 130 along the first path L1 in a reverse direction to be converted to have the second polarization state P2. The second polarization state P2 is, for instance, an S polarization state, and therefore the illumination beam LB having the S polarization state may be reflected by the polarizing beam splitter 110 and then sequentially pass through the second convergence lens 160B, the third convergence lens 160C, and the prism group 170 to illuminate the light valve 200. After the illumination beam LB is converted into the image beam IB by the light valve 200, the image beam IB is projected out of the projection device 1b by the projection lens 300 to form the projection image. Through the above configuration, a reflective optical element (e.g., the second reflector 140B of the light source module 10a) may be further omitted from the projection device 1b, and the effect of reducing the space occupied by the projection device 1b can still be achieved.

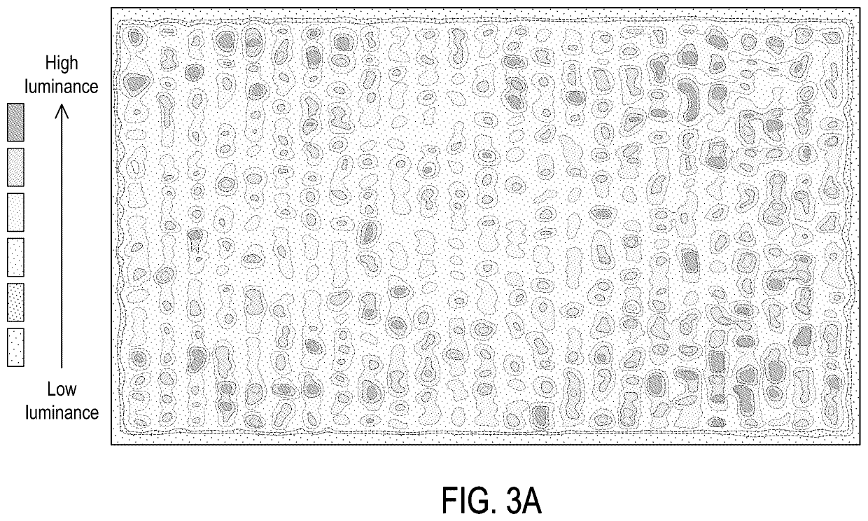

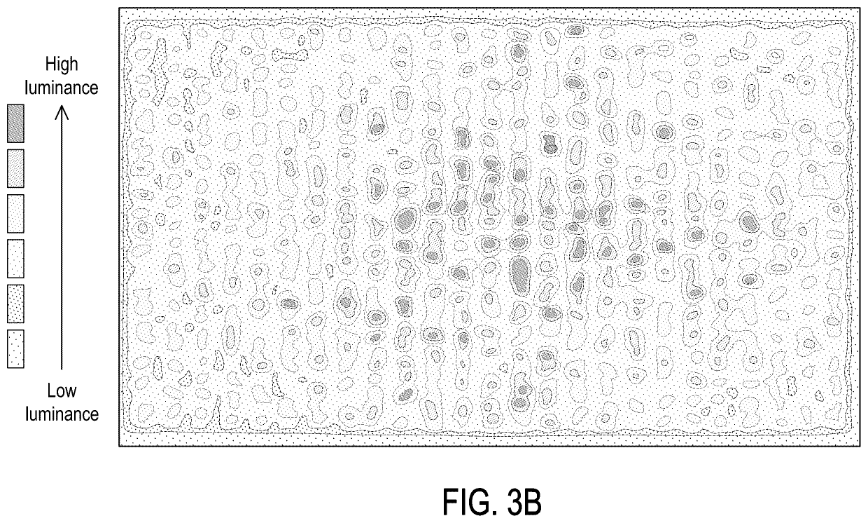

FIG. 3A and FIG. 3B are schematic views illustrating comparison of image beam intensity in the projection device according to respective embodiments of the invention. In the embodiment depicted in FIG. 3A, light may be homogenized through passing through one single lens array 120 back and forth; together with the first reflector 140A which has an appropriate reflection angle and whose reflection surface has an appropriate curvature, the uniformity of the illumination beam LB may be greatly increased. Compared to the conventional projection device, FIG. 3B shows that the distribution of the illumination beam is more concentrated in the center of the image. Specifically, in the display image of FIG. 3A, the minimum light intensity is approximately 92.0% of the maximum light intensity; while in the display image of FIG. 3B, the minimum light intensity is approximately 63.5% of the maximum light intensity; this may also illustrate the light homogenization effect which may be achieved by the light source module 1a or the light source module 1b provided in the embodiments of this invention.

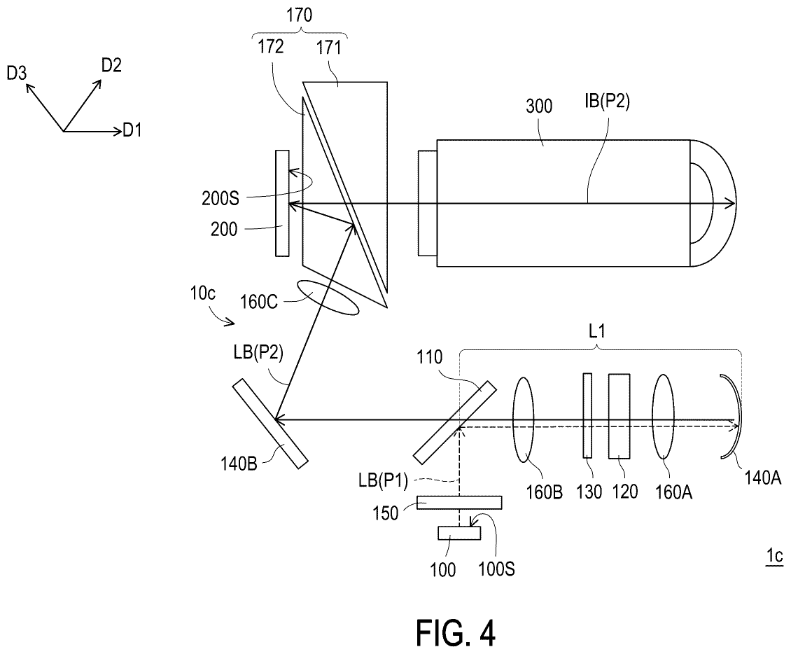

FIG. 4 is a schematic view of a light path of a light source module and a projection device according to yet another embodiment of the invention. With reference to FIG. 4, a projection device 1c and a light source module 10c provided in this embodiment are similar to the projection device 1a and the light source module 10a depicted in FIG. 1, while the main difference therebetween lies in the placement location of the second convergence lens 160B. Specifically, in the light source module 10c of the projection device 1c, the second convergence lens 160B is disposed on one side of the lens array 120 away from the first reflector 140A and between the polarizing beam splitter 110 and the QWF 130.

The configuration described above not only achieves technical effects similar to those achieved by the projection device 1a and the light source module 10a but also addresses the need for a small aperture implementation in the projection system. This is achieved by placing the second convergence lens 160B between the polarizing beam splitter 110 and the QWF 130, which allows the illumination beam LB to be repeatedly converged or focused by the second convergence lens 160B along the first path L1, thereby further shortening the required light path and mitigating the issue of the projection system requiring a longer light path when used with a small aperture.

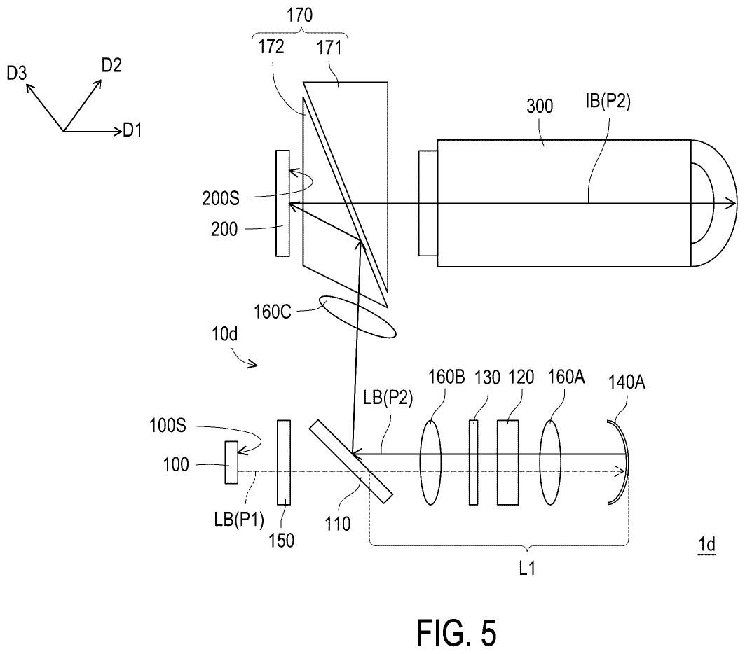

FIG. 5 is a schematic view of a light path of a light source module and a projection device according to still another embodiment of the invention. With reference to FIG. 5, a projection device 1d and a light source module 10d provided in this embodiment are similar to the projection device 1b and the light source module 10b depicted in FIG. 2, while the main difference therebetween lies in the placement location of the second convergence lens 160B. Specifically, in the light source module 10d of the projection device 1d, the second convergence lens 160B is disposed on one side of the lens array 120 away from the first reflector 140A and between the polarizing beam splitter 110 and the QWF 130. Accordingly, the projection device 1d and the light source module 10d may also achieve technical effects similar to those of the projection device 1c and the light source module 10c described above. The relevant explanation may be referred to as those provided in the previous paragraphs and will not be further elaborated.

To sum up, since the lens array of the light source module provided in one or more embodiments of the invention is located between the polarizing beam splitter and the first reflector, the illumination beam may pass through the same lens array repeatedly via the polarizing beam splitter and the first reflector along the first path, and thus the intensity of the illumination beam may be sufficiently homogenized by one single lens array. Compared with the means of homogenizing the illumination beam with a plurality of lens arrays, the means provided in one or more embodiments of the invention significantly simplifies the design of the light path of the light source module. When the light source module is applied to the projection device, the volume is also significantly reduced by nearly 80%. On the other hand, the optimal homogenization effect of the illumination beam may be accomplished simply by adjusting the angle of the first reflector, and the production of the projection device and the light source module is simplified, which indirectly reduces the production difficulty of the product and improves the product yield.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light source module, comprising:
a light source, configured to emit an illumination beam, the illumination beam having a first polarization state;
a polarizing beam splitter, disposed on a light exit side of the light source;
a lens array, disposed on one side of the polarizing beam splitter;
a quarter wave film, disposed between the polarizing beam splitter and the lens array; and
a first reflector, wherein the lens array is disposed between the quarter wave film and the first reflector, the illumination beam from the light source is first transmitted to the polarizing beam splitter and then sequentially transmitted to the quarter wave film, the lens array, and the first reflector along a first path, and after the illumination beam is reflected by the first reflector, the illumination beam is converted into a second polarization state different from the first polarization state, returns along the first path to transmit to the polarizing beam splitter, and is moved away from the polarizing beam splitter after passing through the polarizing beam splitter.

2. The light source module according to claim 1, wherein the reflector is a freeform reflector, a spheric reflector, or a plane mirror.

3. The light source module according to claim 1, further comprising a diffusion sheet disposed between the polarizing beam splitter and the light source.

4. The light source module according to claim 3, wherein the diffusion sheet is an actuating diffusion sheet.

5. The light source module according to claim 1, further comprising:
a first convergence lens, disposed between the reflector and the lens array; and
a second convergence lens, disposed on one side of the lens array away from the first reflector.

6. The light source module according to claim 5, wherein the polarizing beam splitter, the lens array, the first convergence lens, the second convergence lens, and the quarter wave film are all disposed in a first direction.

7. The light source module according to claim 6, further comprising:
a second reflector, wherein the second convergence lens is disposed between the polarizing beam splitter and the second reflector, and the second reflector is configured to reflect the illumination beam from the second convergence lens toward a second direction, the first direction is different from the second direction.

8. The light source module according to claim 7, further comprising:
a prism group, configured to receive the illumination beam from the second reflector and enable the illumination beam to travel in a third direction via total internal reflection; and
a third convergence lens, disposed between the second reflector and the prism group.

9. A projection device, comprising:
a light source module, comprising:
a light source, configured to emit an illumination beam, the illumination beam having a first polarization state;
a polarizing beam splitter, disposed on a light exit side of the light source;
a lens array, disposed on one side of the polarizing beam splitter;
a quarter wave film, disposed between the polarizing beam splitter and the lens array; and
a first reflector, wherein the lens array is disposed between the quarter wave film and the first reflector, the illumination beam from the light source is first transmitted to the polarizing beam splitter and then sequentially transmitted to the quarter wave film, the lens array, and the first reflector along a first path, and after the illumination beam is reflected by the first reflector, the illumination beam is converted into a second polarization state, returns along the first path to transmit to the polarizing beam splitter, and is moved away from the polarizing beam splitter after passing through the polarizing beam splitter; and
a light valve, disposed on a light path of the illumination beam and configured to convert the illumination beam into an image beam; and
a projection lens, disposed on a light exit side of the light valve and configured to transmit the image beam out of the projection device to generate a projection image.

10. The projection device according to claim 9, wherein the reflector is one of a freeform reflector, a spheric reflector, and a plane mirror.

11. The projection device according to claim 9, further comprising a diffusion sheet disposed between the polarizing beam splitter and the light source.

12. The projection device according to claim 11, wherein the diffusion sheet is an actuating diffusion sheet.

13. The projection device according to claim 9, further comprising:
a first convergence lens, disposed between the reflector and the lens array; and
a second convergence lens, disposed on one side of the lens array away from the first reflector.

14. The projection device according to claim 13, wherein the polarizing beam splitter, the lens array, the first convergence lens, the second convergence lens, and the quarter wave film are all disposed in a first direction.

15. The projection device according to claim 14, further comprising:
a second reflector, wherein the second convergence lens is disposed between the polarizing beam splitter and the second reflector, and the second reflector is configured to reflect the illumination beam from the second convergence lens toward a second direction, the first direction is different from the second direction.

16. The projection device according to claim 15, further comprising:
a prism group, disposed between the light valve and the projection lens and used to receive the illumination beam from the second reflector and enable the illumination beam to travel in a third direction through total internal reflection; and
a third convergence lens, disposed between the second reflector and the prism group.
